(19) United States
(12) Patent Application Publication
(10) Pub. No.: US 2024/0252854 A1
(43) Pub. Date: Aug. 1, 2024

(54) SAFTEY LOCKING MECHANISM AND METHOD OF USING THE SAME

(71) Applicant: Honeywell Safety Products USA, Inc., Charlotte, NC (US)

(72) Inventors: Tomas Damek, Frydek-Mistek (CZ); Petr Lopusnik, Brno (CZ); Tanguy Prevot, Nebovidy (CZ)

(21) Appl. No.: 18/161,733

(22) Filed: Jan. 30, 2023

(51) Int. Cl. A62B 35/00

(52) U.S. Cl. CPC A62B 35/0062; E06C 7/187

(57) ABSTRACT

Various embodiments are directed to safety mechanisms for a climbing system and method of using the same. In various embodiments, a safety mechanism comprises a mounting bracket configured to be operatively connected to a fixed guide member defining a guide path configured for shuttle movement therealong; and a safety arm coupled to the mounting bracket and configured for preventing shuttle access to an upper end of the fixed guide member in an instance wherein an extension guide member is not secured in an installed configuration relative to the fixed guide member, wherein the safety arm is configurable to an open position defined by the safety arm engaging the extension guide member to secure the extension guide member in the installed configuration; and wherein the safety arm being engaged with the extension guide member in the open position enables shuttle access to the extension guide member via the guide path.

### TECHNOLOGICAL FIELD

An example embodiment relates generally to safety systems and, more particularly, to a safety system configured for securing one or more objects.

### BACKGROUND

In order to operate effectively, protection devices must be able to freely travel along a guide member to allow freedom of movement, while remaining secured relative to the guide member to ensure that a user connected to the protection device remains operatively coupled to the guide member throughout the length of the guide member. Guide members must be adequately installed and secured for movement of a protection device to be safe for a user. Applicant has identified a number of deficiencies and problems associated with current fall protection devices. Through applied effort, ingenuity, and innovation, many of these identified problems have been solved by the methods and apparatus of the present disclosure.

### BRIEF SUMMARY

Various embodiments are directed to safety mechanisms for climbing systems and methods of using the same. In various embodiments, a safety mechanism for a climbing system comprises a bottom mounting bracket configured to be operatively connected to a fixed guide member, the fixed guide member defining a guide path configured to enable shuttle movement along the fixed guide member; and a safety arm coupled to the bottom mounting bracket such that the safety arm is configured to prevent shuttle access to an upper end of the fixed guide member in an instance wherein an extension guide member is not secured in an installed configuration relative to the fixed guide member; wherein the safety arm is selectively configurable to an open position defined at least in part by the safety arm engaging the extension guide member to secure the extension guide member in the installed configuration; and wherein the safety mechanism is configured such that the safety arm being engaged with the extension guide member in the open position enables shuttle access to the extension rail via the guide path.

In various embodiments, the safety arm may be configured for movement between the open position and a closed position, wherein the closed position of the safety arm is defined at least in part by the safety arm being arranged relative to the fixed guide member such at least a portion of the safety arm embodies a physical obstacle positioned at along the guide path in order to at least partially restrict a range of motion defined by the shuttle. In certain embodiments, the safety arm being positioned in the open position may be further defined by a distal end of the safety arm physically engaging a connection feature provided at an exterior lateral surface of the extension guide member. In certain embodiments, the safety arm may further comprise a first arm portion configured for engagement with the bottom mounting bracket. Further, in certain embodiments, the safety arm may further comprise a second arm portion fixed relative to the first arm portion and defined at least in part by a distal end of the safety arm, the second arm portion being configured to restrict shuttle movement along the guide path when the safety arm is arranged in the closed position and engage the extension guide member when the safety arm is in the open position.

In various embodiments, the bottom mounting bracket may be configured to limit the range of motion of the safety arm. In various embodiments, the safety mechanism may further comprise a top mounting bracket configured to be mounted to the extension guide member. In certain embodiments, the extension guide member may defines at least connection feature configured to receive and secure at least a portion of the safety arm to secure the safety arm in the open position, wherein the top mounting bracket is configured to engage at least a portion of the bottom mounting bracket when the extension guide member is secured in the installed configuration. Further, in certain embodiments, the connection feature may be defined by an orifice configured to receive the safety arm in the open position and at least partially restrict the safety arm from moving in one or more directions relative to the extension guide rail.

In various embodiments, the safety mechanism may further comprise a spring, wherein the spring configured to bias the safety arm towards a closed position. In certain embodiments, the spring may be configured to apply a bias force that opposes a movement of the safety arm from the closed position to the open position. Further, in certain embodiments, the bias force generated by the spring may be defined at least in part by a linear bias force. Further still, in certain embodiments, the bias force generated by the spring may be defined at least in part by a rotational bias force. In various embodiments, the safety arm may further comprise at least one pin configured to prevent the safety arm from over rotating in a vertical direction. In certain embodiments, the pin may be configured to physically abut at one or more surfaces of the bottom mounting bracket to restrict a range of motion of the safety arm relative to the bottom mounting bracket.

In various embodiments, the safety arm may be configured to rotate about a central axis defined by a first arm portion engaged with the bottom mounting bracket. In various embodiments, the safety arm may be configured to move in a plurality of directions relative to the bottom mounting bracket. In certain embodiments, the safety arm may be configured for linear movement and rotational movement relative to the bottom mounting bracket. In certain embodiments, the safety arm may be configured to rotate throughout a range of motion defined at least in part by the pin of the safety arm, wherein the pin is configured to prevent the safety arm from over rotation in one or more of a first rotational direction and a second rotational direction. In various embodiments, the safety arm may comprise, a rigid material configured to withstand the forces applied while in the open position.

### BRIEF SUMMARY OF THE DRAWINGS

Having thus described certain example embodiments of the present disclosure in general terms, reference will hereinafter be made to the accompanying drawings, which are not necessarily drawn to scale, and wherein:

FIGS. 1A-1D depict exemplary front perspective views of an example system translating from a retracted configuration to an extended configuration in accordance with various example embodiments of the present disclosure;

FIG. 2A depicts an exemplary front perspective view of a locking mechanism in accordance with various embodiments of the present disclosure;

FIG. 2B depicts an exemplary back perspective view of a locking mechanism in accordance with various embodiments of the present disclosure;

FIG. 3 depicts an exemplary front perspective view of a locking mechanism movement in accordance with various example embodiments of the present disclosure;

FIG. 4A depicts an exemplary front perspective view of an example handle in a starting position in accordance with various example embodiments of the present disclosure;

FIG. 4B depicts an exemplary front perspective view of an example handle in an open position in accordance with various example embodiments of the present disclosure; and

FIGS. 5A-5E depict exemplary perspective views of an example movement operation of an example system in accordance with various example embodiments of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection device may be referred to use by humans, but may also be used to for safety of objects unless otherwise noted.

The components illustrated in the figures represent components that can or cannot be present in various embodiments of the present disclosure described herein such that embodiments can include fewer or more components than those shown in the figures while not departing from the scope of the present disclosure. Some components can be omitted from one or more figures or shown in dashed line for visibility of the underlying components.

Aspects of the present disclosure are described below with reference to flowchart illustrations. Thus, it should be understood that each block of the flowchart illustrations may be implemented in the form of a solely hardware aspect, a computer program product, a combination of hardware and computer program products, and/or apparatus, systems, computing devices, computing entities, and/or carrying out instructions, operations, steps, and similar words used interchangeably. Accordingly, the flowchart illustrations support various combinations of aspects for performing the specified instructions, operations, or steps.

The phrases “in an example embodiment,” “some embodiments,” “various embodiments,” and the like generally mean that the particular feature, structure, or characteristic following the phrase can be included in at least one embodiment of the present disclosure and can be included in more than one embodiment of the present disclosure (importantly, such phrases do not necessarily refer to the same embodiment).

The word “example” or “exemplary” is used here to mean “serving as an example, instance, or illustration.” Any implementation described herein as “exemplary” is not necessarily to be construed as preferred or advantageous over other embodiments.

If the specification states a component or feature “can,” “could,” “should,” “would,” “preferably,” possibly,” “typically,” “optionally,” “for example,” “often,” or “might” (or other such language) be included or have a characteristic, that a specific component or feature is not required to be included or to have the characteristic. Such components or features can be optionally included in some embodiments or can be excluded.

Current climbing mechanisms can use locking mechanisms that enable removal of the shuttle/fall arrester from the guide rail without confirmation of the extension rail being in an installed configuration, thereby introducing a safety risk that an operator secured to a shuttle may be anchored to an extension rail that is not properly secured. The present disclosure provides various example safety mechanisms for use with a climbing system to allow for effective climbing operations with improved functionality defined at least in part increased safety during operation. Various embodiments are designed to prevent shuttle access to an extension rail positioned above a fixed guide rail until the safety mechanism has secured the extension rail in an installed configuration.

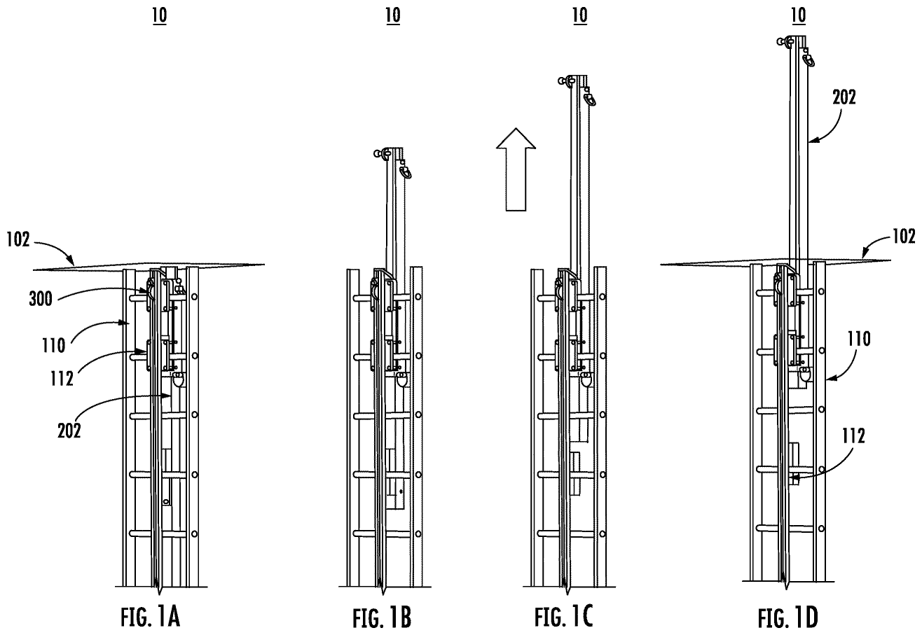

With reference to FIGS. 1A-1D, example perspective views of a climbing system translating from a retracted configuration (e.g., depicted in FIG. 1A) to an extended configuration (e.g., depicted in FIG. 1D) in accordance with various embodiments of the present disclosure. In various embodiments, a climbing system 10 configured to facilitate user access to an opening 102 may include a ladder 110, a guide assembly comprising a fixed guide member 112 and an extension guide member 202. For example, the opening 102 may be configured to be a door, a hatch, and/or the like, that is provided at an elevated surface, wall, and/or roof and may be rearranged between an open and closed configuration. In various embodiments, the opening 102 may be configured to move from the closed configuration to the open configuration via one or more hinges, one or more sliders, and/or the like.

In various embodiments, the guide assembly of an exemplary climbing system 10 may comprise fixed guide member 112 secured relative to the ladder 110. In various embodiments, a fixed guide member 112 may comprise an elongated component defining an internal channel within which the fixed guide member 112 is configured to receive at least a portion of a shuttle 300 to secure the shuttle 300 in a dynamic configuration relative to the fixed guide member 112. The fixed guide member 112 may define a guide path along which the shuttle 300 secured thereto may be translated along the length of the fixed guide member 112. For example, the shuttle 300 may be operatively secure relative to a user (e.g., via wearable safety equipment being worn by the user) in order to anchor the user relative to one or more components of the climbing system 10. The shuttle 300 may be dynamically engaged with the fixed guide member 112 such that as the user climbs and/or descends the ladder 110, the shuttle 300 moves along the guide path defined by the fixed guide member 112 to facilitate a continuous anchoring of the user relative to the ladder 110 (e.g., via the fixed guide member 112). As described herein, the shuttle 300 may be configured for translation in a first direction (e.g., a height direction) along the fixed guide member 112 and/or the extension guide member 202. In various embodiments, the shuttle being provided in an installed configuration relative to the fixed guide member 112 and/or the extension guide member 202 may comprise the shuttle being engaged with the fixed guide member 112 and/or the extension guide member 202 such that the shuttle may move along the length of the fixed guide member 112 and/or the extension guide member 202 during operation thereof, but the movement of the shuttle relative to the fixed guide member 112 and/or the extension guide member 202 in a direction away from the fixed guide member 112 and/or the extension guide member 202 (e.g., perpendicularly away from the internal channel 140) such that the shuttle is secured to the fixed guide member 112 and/or the extension guide member 202.

With further reference to FIGS. 1A-1D, in various embodiments, the extension guide member 202 may be arranged relative to a top end of the ladder 110 and configured to move from a retracted configuration to a deployed configuration to selectively increase the length of the guide path defined by the rail assembly of the climbing system 10 by providing a continuous extension guide path that extends beyond the top end of the ladder 110. In various embodiments, the extension guide member may be configured to be stored in the retracted configuration (e.g., depicted in FIG. 1A), wherein the extension guide member 202 may be disposed beneath the lowermost edge of the opening 102. The extension guide member 202 may be configured to move from the retracted configuration to the deployed configuration (e.g., depicted in FIG. 1D) when the opening 102 is in the open configuration. The extension guide member 202 may be configured to be disposed, at least partially, above the upper most edge of the opening 102 while in the deployed configuration. In various embodiments, the extension guide member 202 may be configured to be mounted relative to a top end of the fixed guide member 112, such that in the deployed configuration, the extension guide member 202 effectively extends and/or increases the length of a channel defined by the fixed guide member 112. With further reference to FIGS. 1A-1D, the opening 102 may be in the open configuration, such that, the one or more extend guide member 202 may be configured to extend through the opening 102 at least partially, as depicted in FIGS. 1B-1C. In various embodiments, the extending guide member 202 is configured to translate in the first direction (e.g., the height direction) from the retracted configuration to the extended configuration, depicted in FIG. 1D. In various embodiments, the climbing system 100 in the extended configuration may be configured for allowing one or more shuttle to translate through the opening 102.

With further reference to FIGS. 1A-1D, in various embodiments, the extension guide member 202 may be configured to move from a retracted configuration to an extended configuration relative to the fixed guide member. In various embodiments, the extension guide member 202 may be configured such that a movement from the retracted configuration, as illustrated in FIG. 1A, to a fully extended configuration, as illustrated in FIG. 1D, may be defined by an at least substantially vertical translation of the extension guide member 202 relative to the fixed guide member 112. For example, the extension guide member 202 may be configured to translate from the retracted configuration a predetermined distance in a first direction (e.g., a height direction) such that the lower most edge of the extension guide member 202 is disposed above the upper most edge of the fixed guide member 112. In various embodiments, the extension guide member 202 and the fixed guide member 112 may be configured such that upon the extension guide member 202 being arranged in an extended configuration and secured in an installed configuration (e.g., via the safety mechanism 100), as described herein, the respective channels of the fixed and extension guide members 112, 202 may be at least substantially aligned with one another, so as to collectively define an at least substantially continuous guide path along which the shuttle 300 may be moved.

In various embodiments, the climbing system 100 may include a safety mechanism configured to facilitate the arrangement of the extension guide member 202 in an installed configuration relative to the fixed guide member 112 and prevent shuttle 300 access to the extension guide member 202 until the extension guide member 202 is secured in the installed configuration. For example, as described herein, the safety mechanism 100 may comprise an operatively mounted relative to the fixed guide member 112 (e.g., via a mounting bracket) that is configured to be selectively moved to engage the extension guide member 202 when the in extension guide member 202 is in the fully extended configuration in order to operatively secure the extension guide member 202 in an installed configuration relative to the fixed guide member 112.

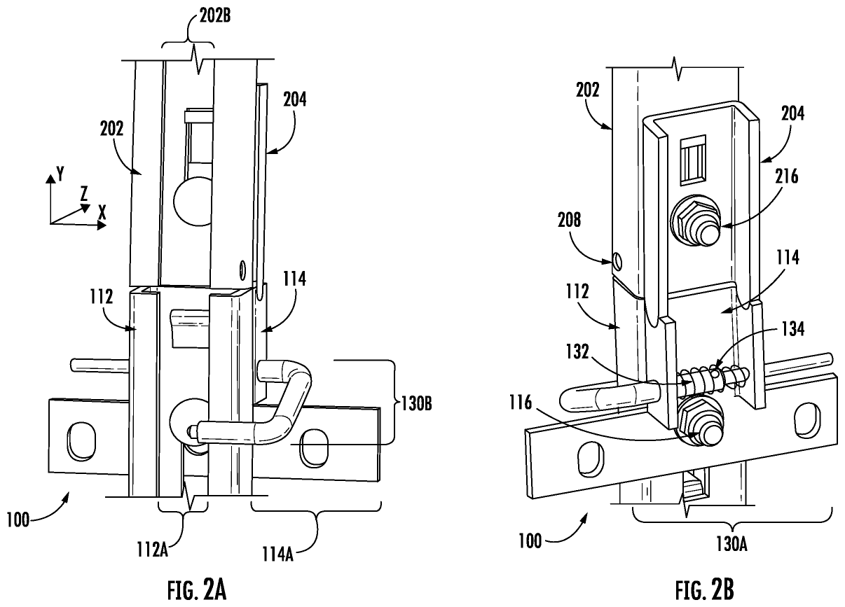

FIGS. 2A and 2B illustrate various perspective views of an exemplary safety mechanism for a climbing system according to various embodiments described herein. In particular, FIGS. 2A and 2B illustrate a front perspective view and a rear perspective view, respectively, of an exemplary safety mechanism 100 mounted relative to the rail assembly of a climbing system. As illustrated, an exemplary safety mechanism may comprise a bottom mounting bracket 114 configured to be mounted relative to a fixed guide member 112 of the climbing system. For example, the bottom mounting bracket 114 may be mounted to a rear surface (e.g., a surface defining a back side of the guide member facing away from the shuttle opening of the guide member) of the fixed guide member 112 via one or more fastener elements 116 (e.g., threaded fasteners). As illustrated, the bottom mounting bracket 114 may be mounted at least substantially adjacent the top end of the fixed guide member 112.

In various embodiments, the exemplary safety mechanism 100 may comprise a top bottom mounting bracket 204 configured to be mounted relative to an extension guide member 202 of the climbing system. For example, the top mounting bracket 204 may be mounted to a rear surface of the extension guide member 202 via one or more fastener elements 126 (e.g., threaded fasteners). As illustrated, the top mounting bracket 204 may be mounted at least substantially adjacent the bottom end of the extension guide member 202.

In various embodiments, the top mounting bracket 204 may be configured to engage the bottom mounting bracket 114 upon the extension guide member 202 being positioned in the extended configuration, so as to at least partially restrict the movement of the extension guide member 202 (e.g., a bottom end of the extension guide member 202) relative to the fixed guide member 112 in one or more directions. For example, the top mounting bracket 204 may define one or more interface features (e.g., a protrusion, bump, and/or the like) provided a bottom end thereof that are configured to physically engage a corresponding one or more interface features defined by the bottom mounting bracket 114 (e.g., a concave groove, recess, indention, and/or the like) when the extension guide member 202 is in the extended configuration.

In various embodiments, the safety mechanism 100 may further comprise a safety arm 130 mounted to the bottom mounting bracket 114 in a dynamic configuration such that at least a portion of the safety arm 130 is selectively moveable relative to the fixed guide member 112. In various embodiments, the safety arm 130 is configured to be attached to the bottom mounting bracket 114 at a first arm portion 130A that is rotatably secured to the bottom mounting bracket 114 such that the safety arm 130 is selectively rotatable about the central axis of the first arm portion 130A. As illustrated, the safety arm 130 may be secured relative to the bottom mounting bracket 114 such that the central axis of the first arm portion 130A defining the axis of rotation of the safety arm 130 is oriented in an at least substantially lateral direction (e.g., in the to the x-direction as defined in the exemplary orientation illustrated in FIG. 2A). In various embodiments, the safety arm 130 comprises a second arm portion 130B defining a distal end of the safety arm 130 that configured for movement relative to the fixed guide member 112 and./or the extension guide member 202 in order to obstruct a guide path defined by the fixed guide member 112 and/or engage a connection feature defined by the extension guide member 202 to secure the extension guide member 202 in extended configuration relative to the upper end of the fixed guide member 112 (e.g., in an installed configuration). For example, in various embodiments, the second arm portion 130B may comprise an at least partially linear and/or curved shape configured to facilitate operator interaction with the safety arm 130.

As described herein, the safety arm 130 of an exemplary safety mechanism 100 may be selectively configurable between a closed position and an open position to restrict shuttle access to at least a portion of the guide path defined by the fixed guide member 112 and/or secure the extension guide member 202 in an installed configuration relative to the fixed guide member 112. For example, the safety arm 130 may be configured such that in the closed position, as depicted by the exemplary embodiment shown in FIGS. 2A and 2B, the safety arm 130 intersects the guide path defined by the fixed guide member 112 to prevent a shuttle installed within the fixed guide member 112 from further movement towards the upper end of the fixed guide member 112. Further, as described herein, the safety arm 130 may be configured such that a user may selectively rearrange the safety arm 130 from the closed configuration to an open configuration in which the second arm portion 130B of the safety arm 130 engages an extension guide member 202 provided in the extended configuration to secure the extension guide member 202 in an installed configuration relative to the upper end of the fixed guide member 112.

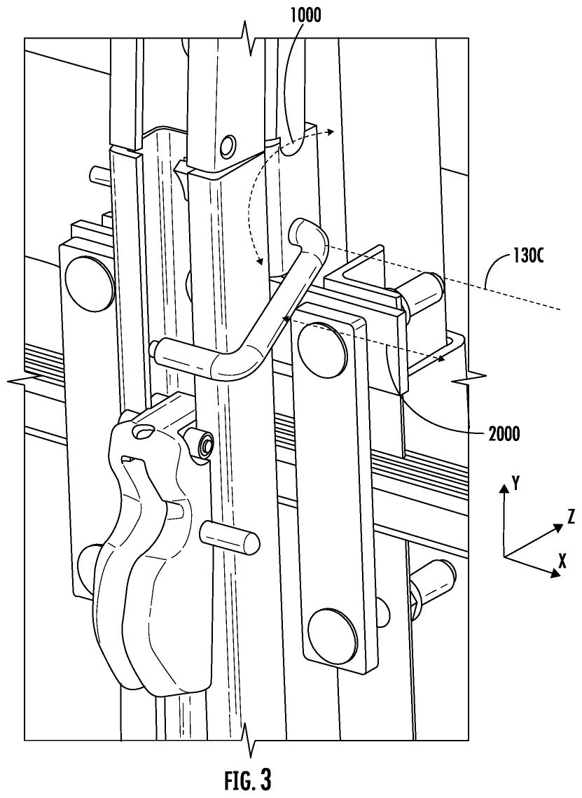

In various embodiments, the safety arm 130 is dynamically mounted relative to the bottom mounting bracket 114 such that the first arm portion 130A of the safety arm 130 is configured for both linear translation and rotation relative to the bottom mounting bracket 114. For example, FIG. 3 illustrates a perspective view of an exemplary safety mechanism comprising a safety arm dynamically mounted to a bottom mounting bracket in accordance with various embodiments described herein. As illustrated, the safety arm 130 may be operatively connected to the first mounting bracket 114 such that a user may selectively move the safety arm 130 in one or more lateral directions 2000 through a linear range of motion defined relative to the bottom mounting bracket 114. Further, the user may also selectively rotate the safety arm 130 about a central axis 130C of the first arm portion in one or more rotational directions 1000 through a rotational range of motion defined relative to the bottom mounting bracket 114. In one or more embodiments, the safety arm may be configured to move in a rotational direction 1000 and a lateral direction 2000 simultaneously and/or sequentially.

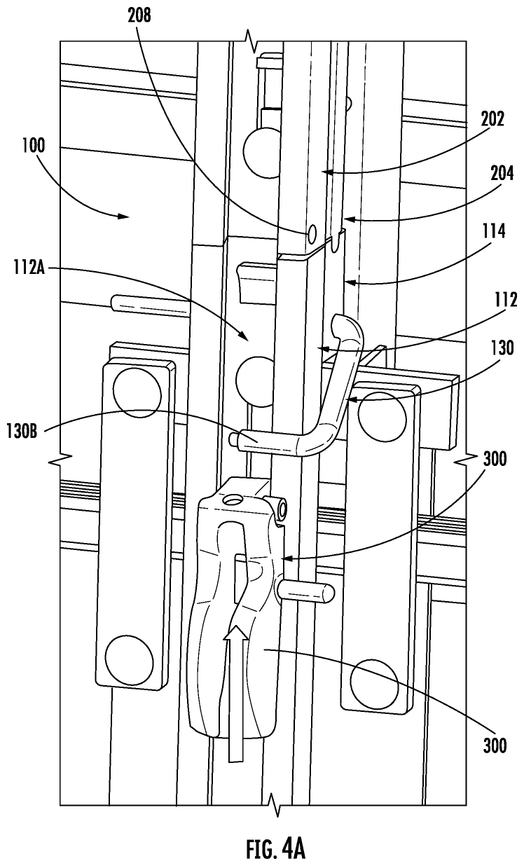

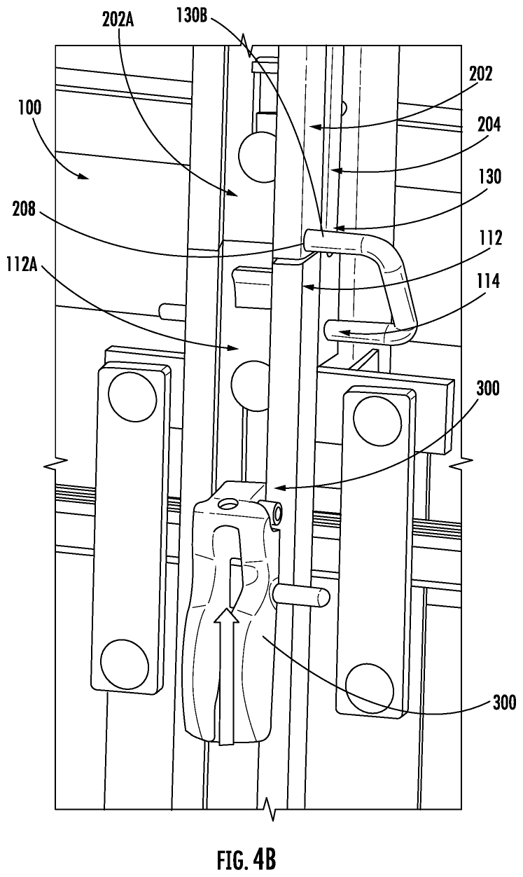

FIGS. 4A and 4B illustrate various perspective views of an exemplary climbing system comprising a safety mechanism according to various embodiments described herein. In particular, FIGS. 4A and 4B illustrate an exemplary safety mechanism 100 for a climbing system comprising a safety arm configured in a closed position and an open position, respectively, relative to the rail assembly of the climbing system. In various embodiments, as depicted in FIG. 4A, an safety arm 130 may be disposed in a closed position defined by the safety arm 130 being arranged relative to the fixed guide member 112 such that the second arm portion 130B overlaps and/or intersects the channel 112A of the fixed guide member 112 (e.g., the guide path defined by the fixed guide member 112) to prevent a shuttle 300 from accessing an upper end of the fixed guide member 112 by restricting the shuttle 300 from moving beyond the safety arm 130. In the closed position, the second arm portion 130B of the safety arm 130 may be configured to physically abut at least a portion of the shuttle 300 travelling along the guide path defined by the fixed guide member 112 to prevent the shuttle 300 from advancing further in a first direction (e.g., a height direction) within the channel 112A towards an extension guide member 202 that is in an extended configuration, but has not yet been safely secured in an installed configuration relative to the top end of the fixed guide member 112.

As described herein, the safety arm 130 may be configured for selective movement between the closed position and an open position based on user interaction therewith defined by an operator moving the safety arm 130 in one or more directions to rearrange the safety arm 130 to the open position illustrated in FIG. 4B. As illustrated in FIG. 4B, the safety arm 130 being disposed in an open position may be defined by the second arm portion 130B of the safety arm 130 being engaged with a connection feature 208 defined by the extension guide member 202 such that the safety arm 130 is operatively coupled to the extension guide member 202 to extension guide member 202 in an installed configuration relative to the fixed guide member 112. In various embodiments, the connection feature 208 defined by extension guide member 202 may embody an orifice, a receiving slot, a fastener element, and/or any other mechanical means for detachably coupling the second arm portion 130B relative to the extension guide member 202. As illustrated, the connection feature 208 may be defined along a lateral side surface of the expandable guide member 202 in a position at least substantially proximate the bottom end of the expandable guide member 202. For example, in the open position, the second arm portion 130B of the safety arm 130 may be configured to physically engage the extension guide member 202 (e.g., the connection feature 208) so as to restrict the bottom end of the extension guide member 202 from moving relative to the fixed guide member 112 in one or more directions (e.g., in any direction).

The safety arm 130 being in the open position may further be defined by an arrangement of the safety arm 130 in which the second arm portion 130B does not overlap and/or intersect the channel 112A of the fixed guide member 112 (e.g., the guide path defined by the fixed guide member 112). For example, the second arm portion 130B of the safety arm 130 being received within the connection feature 208 of the extension guide member 202 may correspond to an unobstructed guide path defined along the channel 112A of the fixed guide member 112 that enables the shuttle 300 to move toward the upper end of the fixed guide member 112 and access an extension channel 202A defined by the extension guide member 202. In various embodiments, the safety mechanism 100 is configured such that the safety arm 130 allows for unobstructed shuttle 300 access to the extension guide path 202A defined by the extension guide member 202 only upon the safety arm 130 being used to secure the extension guide member 202 in an installed configuration.

Referring back to FIGS. 2A and 2B, in various embodiments, an exemplary safety mechanism 100 may further comprise a biasing spring 132 operatively connected to the adjustment handle 130 and configured to apply one or more forces thereto to bias the adjustment handle 130 towards a nominal configuration. In various embodiments, the spring 132 may be secured at a first end to the first arm portion 130A of the safety arm 130 and engaged at an opposite second spring end with an interior lateral surface of the bottom mounting bracket 114. In various embodiments, the spring 132 may be configured to apply a bias force to the safety arm 130 that is defined at least in part by a linear force that biases the safety arm in an inward lateral direction, such as, for example, in the negative x-direction as defined in the exemplary orientation illustrated in FIG. 2A. As described herein, the biasing force acting on the safety arm 130 may oppose the movement of the safety arm 130 in the outward lateral direction such that the safety arm 130 is biased towards a closed position in which the second arm portion extends over at least a portion of the channel defined by the fixed guide member 112. For example, a user pulling the safety arm 130 in an outward lateral direction (e.g., in the positive x-direction, as defined in the exemplary orientation illustrated in FIGS. 2A and 2B) may cause the spring 132 to be compressed from a first compressed position to a second compressed position. In such an exemplary circumstance, as the spring 132 is compressed to the second compressed position as the first arm portion 130A of the safety arm 130 translates in the outward lateral direction relative to the bottom mounting bracket 114. The spring 132 may be configured to impart an at least substantially continuous force on the safety arm 130 that biases the second arm portion 130B towards an engagement with one of the fixed guide member 112 and the extension guide member 202.

Further, in various embodiments, the spring 132 may be configured to apply a bias force to the safety arm 130 that is defined at least in part by a rotational force that biases the safety arm 130 in a rotational direction towards the fixed guide member 112, such as, for example, in the counterclockwise rotational direction about the central axis of the first arm portion 130A, as defined in the exemplary orientation illustrated in FIG. 2A. As described herein, such a rotational biasing force imparted on the safety arm 130 from the spring 132 may oppose the movement of the safety arm 130 in the clockwise rotational direction towards the extension guide member 202 such that the safety arm 130 is biased towards the closed position in which the second arm portion 130B is physically engaged with a surface of the fixed guide member 112 at least substantially adjacent the channel 112A. For example, a user rotating the safety arm 130 in a clockwise direction, as defined in the exemplary orientation illustrated in FIGS. 2A and 2B, may oppose the rotational bias force generated by the spring 132. The spring 132 may be configured to impart an at least substantially continuous force on the safety arm 130 that biases the second arm portion 130B in a rotational direction at least substantially away from the extension guide member 202 and towards an engagement with the fixed guide member 112.

In various embodiments, the spring 132 may be configured such that a user is required to apply one or more forces sufficient to at least substantially counteract the biasing force acting on the safety arm 130 in order to initiate the multi-directional, dual-action operation required to move the safety arm 130 from the closed position to an open position. That is, the spring 132 disposed between the bottom mounting bracket 114 and the first arm portion 130A of the safety arm 130 may be configured to bias the safety arm 130 towards the nominal position in which at least a portion of the safety arm 130 is pressed against an exterior lateral surface of the fixed guide member 112 such that the second arm portion 130B is disposed in an overlapping relative to at least a portion of the channel defined by the fixed guide member 112.

Further, in various embodiments, the exemplary safety mechanism 100 may further comprise a pin 134 provided along a first arm portion 130A of the safety arm 130 and configured to restrict the range of rotational motion of the safety arm in one or more directions. For example, the pin may protrude in an outward direction away from the first arm portion 130A such that the pin 134 is rotated about the central axis of the first arm portion 130A with the first arm portion 130A. In various embodiments, the pin 134 may be configured to define the extent to which the safety arm 130 can be rotated in one or more rotational directions. For example, the pin 134 may be configured such that, upon the safety arm 130 being rotated in a clockwise position to a maximum angular position defined relative to the extension guide member 202, the pin 134 may physically abut a surface of the bottom mounting bracket 114 to prevent further rotation of the safety arm 130 in the clockwise position. Further, the pin 134 may be configured such that, upon the safety arm 130 being rotated in a counter-clockwise position to a corresponding maximum angular position defined relative to the fixed guide member 112, the pin 134 may physically about a surface of the bottom mounting bracket 114 to prevent further rotation of the safety arm 130 in the counter-clockwise position. Further still, in various embodiments, the pin 134 function to at least partially restrict the range of linear motion of the safety arm 130 relative to the bottom mounting bracket 114 by being configured to physically abut an interior lateral surface of the bottom mounting bracket 114 when the safety arm 130 reaches an outermost lateral position to prevent further movement of the safety arm 130 in the outward lateral direction.

Further, in various embodiments, the bottom mounting bracket 114 may be defined at least in part by a bracket extension 114A. For example, the bracket extension 114A may extend in a lateral direction at least substantially perpendicular to the length of the fixed guide member 112 such that the outermost end of the bracket extension 114A is further away from the fixed guide member 112 than any portion of the spring 132 when the spring 132 is in its outermost lateral position.

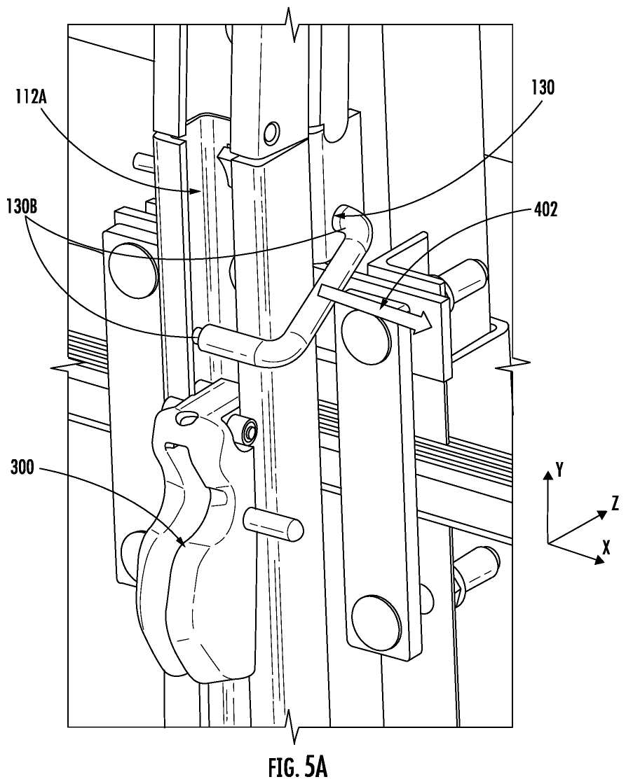

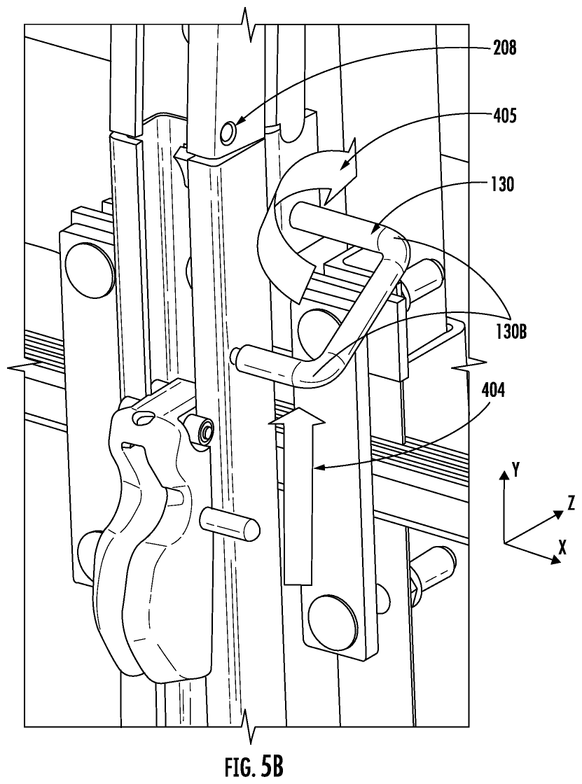

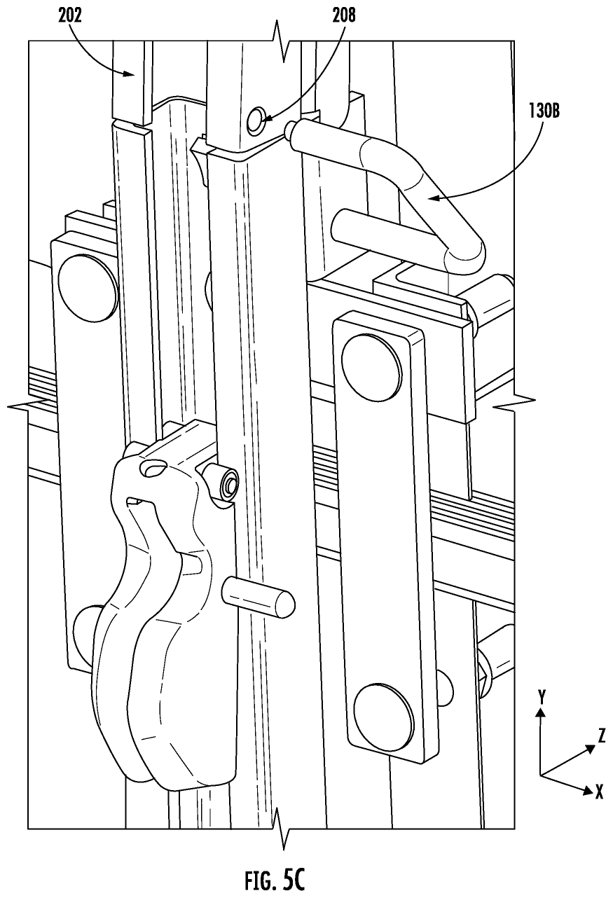

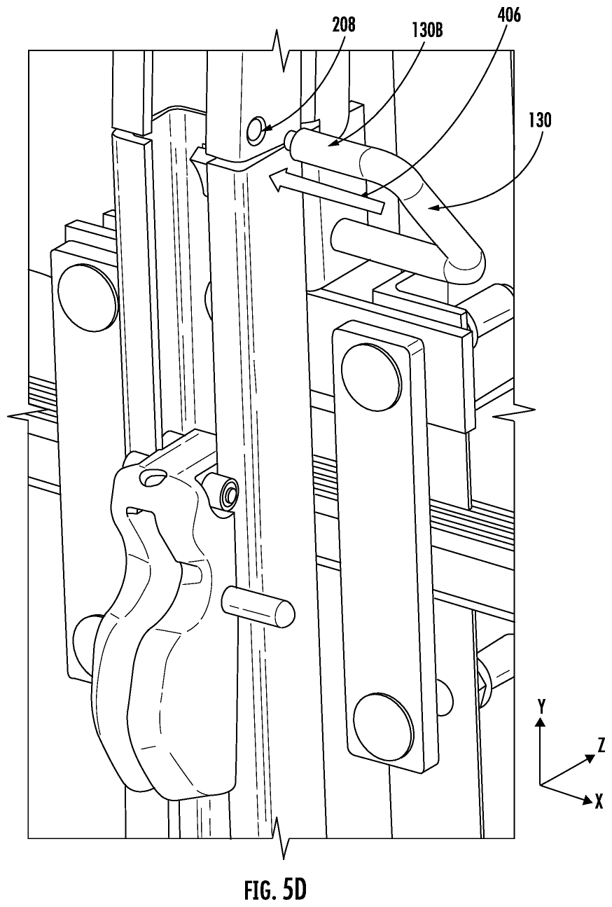

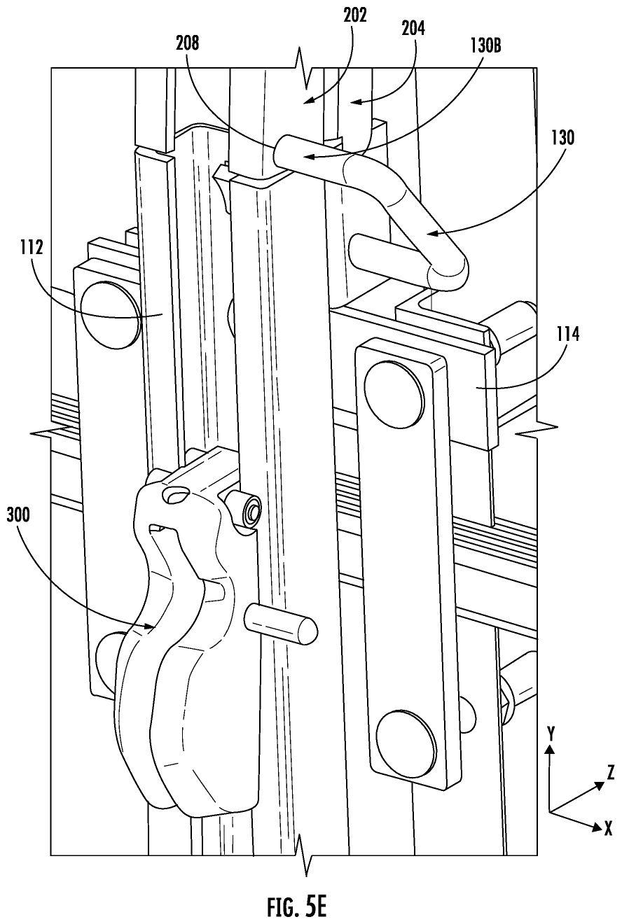

As described herein, the safety mechanism may be configured such reconfiguring the safety arm 130 from the closed position to the open position requires a user to execute a dual-action operation including a first pull action and a subsequent rotation action. For example, FIGS. 5A-5E illustrate various iterative steps defining the operation of moving the safety arm 130 from a closed position to an open position. As illustrated in FIG. 5A, a user interaction with a safety arm 130 provided in a closed position may be embodied at least in part by a portion of the safety arm 130 being pulled and/or otherwise moved in an outward direction lateral direction (e.g., in the positive x-direction as defined in the exemplary orientation illustrated in FIGS. 5A-5E) away from the channel 112A of the fixed guide member 112. For example, a user may impart a pulling force 402 on the safety arm 130 in an at least substantially outward lateral direction away from the fixed guide member 112 to cause the second arm portion 130B to be moved laterally away from the channel 112A. The safety mechanism 100 may be configured such that the outward lateral pulling force 402 may at least overcome the spring biasing force acting on the safety arm 130. As illustrated, the pulling force 402 may be defined in a direction that is at least substantially parallel to the central axis defined by the bottom mounting bracket 114, such that the pulling force 402 causes the safety arm 130 to be linearly translated relative to the bottom mounting bracket 144. The exemplary pulling force 402 may cause the safety arm 130 to be moved from a nominal position (e.g., a resting and/or stabilized position), as illustrated in FIG. 5A. As a non-limiting example, the nominal position of the safety arm 130 may be represented by the closed position, as described herein, and may be further defined by at least a portion of the safety arm 130 being physically abutted against an exterior lateral surface of the fixed guide member 112 and/or the second arm portion 130B being disposed above the channel 112A of the fixed guide member 112.

With reference to FIG. 5B, as a result of the pulling force 402 illustrated in FIG. 5A, the safety arm 130 is show in an extended position wherein the safety arm 130 has been moved in an outward direction along the bottom mounting bracket such that at least substantially all of the safety arm 130 is disengaged with the fixed guide member. For example, in FIG. 5B, upon the safety arm 130 being arranged in an extended configuration, as illustrated, the dual-action operation defined by the safety mechanism 100 may further require a subsequent action in which the user applies an upward linear force 404 to the second arm portion 130B of the safety arm 130 to cause a non-lateral torque and/or a moment to be imparted on the safety arm 130 such that the safety arm 130 exhibits a rotation 405 towards the extension guide member 202 (e.g., a clockwise rotation as defined by the exemplary orientation illustrated in FIGS. 5A-5E). For example the safety arm 130 may be configured such that the second force 404 applied to the safety arm 130 by the user may impart a non-lateral torque and movement on the second arm portion 130B that causes the safety arm 130 to rotate about the central axis defined by the first arm portion 130A in clockwise rotational direction. In various embodiments, the second arm portion 130B may remain in an outward lateral position relative to the extension guide member 202 throughout the rotation 405 of the safety arm 130 such that the second arm portion 130B does not physically abut a surface of the extension guide member 202 during the rotation 405.

In various embodiments, the second force 404 may be applied to the second arm portion 130B of the safety arm 130 until the safety arm 130 has been rotated to a position wherein the second arm portion 130B is at least substantially level with the connection feature 208 defined by the extension guide member 202, as illustrated in FIG. 5C. With reference to FIG. 5C, as a result of the rotation 405, the second arm portion 130B is arranged in an at least substantially aligned (e.g., coaxial) configuration with connection feature 208 provided along the exterior lateral surface of the extension guide member 202.

In various embodiments, upon the second arm portion 130B being at least substantially aligned with the connection feature 208 of the extension guide member 202, as depicted in FIG. 5D, the user may at least partially release the safety arm 130 such that a retention force 406 acting on the safety arm 130 via the biasing spring (not shown) acts as a pulling force to pull the safety arm 130 in an inward direction toward the extension guide member 202. As described herein, the biased configuration of the safety arm 130 caused by the biasing spring may generate a retention force 406 that acts on the safety arm 130 to move the second arm portion 130 in an inward lateral direction toward the connection feature 208 (e.g., in the negative x-direction, as defined by the exemplary orientation illustrated in FIGS. 5A-5E). In various embodiments, the connection feature 208 is configured to receive at least a portion of the second arm portion 130B therein, such that the safety arm 130 engages the extension guide member 202 to prevent the bottom end thereof from moving relative to the bottom mounting bracket 114 and/or the fixed guide member 112. As illustrated in FIG. 5E, upon the second arm portion 130B being received by the connection feature 208 of the extension guide member 202, the safety arm 130 is arranged in an open position, wherein the safety arm 130 functions to secure the extension guide member 202 in an installed configuration defined by the top mounting bracket 204 being operatively engaged with the bottom mounting bracket 114, as described herein, and the extension guide member 202 being secured in a position above the top end of the fixed guide member 112 such that the respective channels defined by the fixed and extension guide members 122, 202 collectively define an at least substantially continuous guide path for shuttle 300 movement. As illustrated, an exemplary safety mechanism may be configured such that open position of the safety arm 130 is defined by the guide path defined by the fixed guide member 112 being unobstructed to enable shuttle movement along the entire length of the fixed guide member 112. In particular, the dual-action operation required to move the safety arm 130 from the closed position to the open position is defined at least in part by the second arm portion 130B being moved away from the overlapping and/or intersecting arrangement with respect to the channel 112A of the fixed guide member 112 such that an extension guide path defined by the extendable guide rail 202 is accessible to the shuttle 300 via the channel 112A of the fixed guide member 112. In various embodiments, the retention force 406 applied by the biasing spring of the safety mechanism may be configured to secure and/or retain the second arm portion 130B within the connection feature 208 in order to prevent unintentional disengagement of the safety arm 130 from the extension guide member 202.

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A safety mechanism for a climbing system, the safety mechanism comprising,
a bottom mounting bracket configured to be operatively connected to a fixed guide member, the fixed guide member defining a guide path configured to enable shuttle movement along the fixed guide member; and
a safety arm coupled to the bottom mounting bracket such that the safety arm is configured to prevent shuttle access to an upper end of the fixed guide member in an instance wherein an extension guide member is not secured in an installed configuration relative to the fixed guide member;
wherein the safety arm is selectively configurable to an open position defined at least in part by the safety arm engaging the extension guide member to secure the extension guide member in the installed configuration; and
wherein the safety mechanism is configured such that the safety arm being engaged with the extension guide member in the open position enables shuttle access to the extension guide member via the guide path.

2. The safety mechanism of claim 1, wherein the safety arm is configured for movement between the open position and a closed position, wherein the closed position of the safety arm is defined at least in part by the safety arm being arranged relative to the fixed guide member such at least a portion of the safety arm embodies a physical obstacle positioned at along the guide path in order to at least partially restrict a range of motion defined by the shuttle.

3. The safety mechanism of claim 2, wherein the safety arm being positioned in the open position is further defined by a distal end of the safety arm physically engaging a connection feature provided at an exterior lateral surface of the extension guide member.

4. The safety mechanism of claim 2, wherein the safety arm further comprises a first arm portion configured for engagement with the bottom mounting bracket.

5. The safety mechanism of claim 4, wherein the safety arm further comprises:
a second arm portion fixed relative to the first arm portion and defined at least in part by a distal end of the safety arm, the second arm portion being configured to restrict shuttle movement along the guide path when the safety arm is arranged in the closed position and engage the extension guide member when the safety arm is in the open position.

6. The safety mechanism of claim 1, wherein the bottom mounting bracket is configured to limit the range of motion of the safety arm.

7. The safety mechanism of claim 1, further comprising a top mounting bracket configured to be mounted to the extension guide member.

8. The safety mechanism of claim 7, wherein the extension guide member defines at least connection feature configured to receive and secure at least a portion of the safety arm to secure the safety arm in the open position, wherein the top mounting bracket is configured to engage at least a portion of the bottom mounting bracket when the extension guide member is secured in the installed configuration.

9. The safety mechanism of claim 8, wherein the connection feature is defined by an orifice configured to receive the safety arm in the open position and at least partially restrict the safety arm from moving in one or more directions relative to the extension guide rail.

10. The safety mechanism of claim 1, further comprising a spring, wherein the spring configured to bias the safety arm towards a closed position.

11. The safety mechanism of claim 10, wherein the spring is configured to apply a bias force that opposes a movement of the safety arm from the closed position to the open position.

12. The safety mechanism of claim 11, wherein the bias force generated by the spring is defined at least in part by a linear bias force.

13. The safety mechanism of claim 12, wherein the bias force generated by the spring is defined at least in part by a rotational bias force.

14. The safety mechanism of claim 1, wherein the safety arm further comprises at least one pin configured to prevent the safety arm from over rotating in a vertical direction.

15. The safety mechanism of claim 14, wherein the pin is configured to physically abut at one or more surfaces of the bottom mounting bracket to restrict a range of motion of the safety arm relative to the bottom mounting bracket.

16. The safety mechanism of claim 1, wherein the safety arm is configured to rotate about a central axis defined by a first arm portion engaged with the bottom mounting bracket.

17. The safety mechanism of claim 1, wherein the safety arm is configured to move in a plurality of directions relative to the bottom mounting bracket.

18. The safety mechanism of claim 17, wherein the safety arm is configured for linear movement and rotational movement relative to the bottom mounting bracket.

19. The safety mechanism of claim 18, wherein the safety arm is configured to rotate throughout a range of motion defined at least in part by the pin of the safety arm, wherein the pin is configured to prevent the safety arm from over rotation in one or more of a first rotational direction and a second rotational direction.

20. The safety mechanism of claim 1, wherein the safety arm comprises, a rigid material configured to withstand the forces applied while in the open position.
